(19) United States
(12) Patent Application Publication
(10) Pub. No.: US 2026/0281537 A1
(43) Pub. Date: Sep. 17, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventors: KANA UEDA, TOKYO (JP); MIDORI MIWA, TOKYO (JP)

(21) Appl. No.: 19/167,601

(22) PCT Filed: Mar. 25, 2024
(86) PCT No.: PCT/JP2024/011643

§ 371 Date: Sep. 22, 2025

(30) Foreign Application Priority Data
Apr. 10, 2023 (JP) 2023-063716

(51) Int. Cl. H04N 23/62; G06V 10/762; H04N 23/63

(52) U.S. Cl. CPC H04N 23/62; G06V 10/762; H04N 23/631

(57) ABSTRACT

An information processing device includes a user interface control unit that performs control to cause a list of setting values of setting items related to a plurality of cameras to be displayed, to perform difference determination processing of setting values for each of common setting items related to a plurality of the cameras, and to cause display according to a difference determination result to be executed together with the list display.

### TECHNICAL FIELD

The present technology relates to an information processing device, an information processing method, and a program, and particularly to a camera setting monitoring technology in a case where a plurality of cameras is operated in broadcasting operations.

### BACKGROUND ART

In broadcasting operations, a large number of cameras are operated in real time.

Patent Document 1 below discloses a technique related to a camera system for professional use used in a broadcasting station or the like.

### CITATION LIST

### Patent Document

Patent Document 1: Japanese Patent No. 4475225

### SUMMARY OF THE INVENTION

### Problems to be Solved by the Invention

In broadcasting operations for operating a large number of system devices in real time, a staff called a video engineer needs to compare and monitor setting values of a plurality of cameras. Furthermore, demand for remote production of broadcast video is also increasing.

However, in practice, the visibility of a list of device setting values is insufficient, which needs to individually confirm and operate setting values of a plurality of cameras, for example, and a system suitable for comprehensive monitoring use or remote operation use for a plurality of cameras is desired.

Therefore, an object of the present technology is to provide a user interface suitable for monitoring and setting of a plurality of cameras.

### Solutions to Problems

An information processing device according to the present technology includes a user interface control unit that performs control to cause a list of setting values of setting items related to a plurality of cameras to be displayed, to perform difference determination processing of setting values for each of common setting items related to a plurality of the cameras, and to cause display according to a difference determination result to be executed together with the list display.

In a case where imaging is performed by a plurality of cameras in a broadcasting station or the like, the setting values related to the respective cameras can be listed. In this case, difference determination processing of each camera is performed with respect to various setting items, and the determination result, that is, a setting value is clearly indicated so that a setting value having a difference is determined to be abnormal.

### BRIEF DESCRIPTION OF DRAWINGS

FIG. 1 is an explanatory diagram of a configuration of a camera setting monitoring system according to an embodiment of the present technology.

FIG. 2 is a block diagram of a configuration of an information processing device according to the embodiment.

FIG. 3 is an explanatory diagram of a transition of a user interface screen according to the embodiment.

FIG. 4 is an explanatory view of an operation panel screen according to the embodiment.

FIG. 5 is an explanatory view of an operation panel screen according to the embodiment.

FIG. 6 is a flowchart of processing related to a sub control panel according to the embodiment.

FIG. 7 is an explanatory view of a camera cable screen according to the embodiment.

FIG. 8 is an explanatory view of a paint screen according to the embodiment.

FIG. 9 is an explanatory view of a paint screen according to the embodiment.

FIG. 10 is an explanatory view of a paint screen according to the embodiment.

FIG. 11 is an explanatory view of a detailed setting screen of the paint screen according to the embodiment.

FIG. 12 is an explanatory diagram of a smart alert function according to the embodiment.

FIG. 13 is a flowchart of a processing example of the smart alert function according to the embodiment.

FIG. 14 is an explanatory view of a log screen according to the embodiment.

FIG. 15 is an explanatory view of a diagnosis screen according to the embodiment.

FIG. 16 is an explanatory view of an HDR screen according to the embodiment.

FIG. 17 is an explanatory view of an HDR screen according to the embodiment.

FIG. 18 is a flowchart of processing of a compare function according to the embodiment.

### MODE FOR CARRYING OUT THE INVENTION

Hereinafter, an embodiment will be described in the following order.
<1. System Configuration>
<2. User Interface Screen>
[2-1: Screen Transition]
[2-2: Operation Panel Screen]
[2-3: Camera Cable Screen]
[2-4: Paint Screen]
[2-5: Log Screen]
[2-6: Diagnosis Screen]
[2-7: HDR Screen]
<3. Summary and Modifications>

### 1. SYSTEM CONFIGURATION

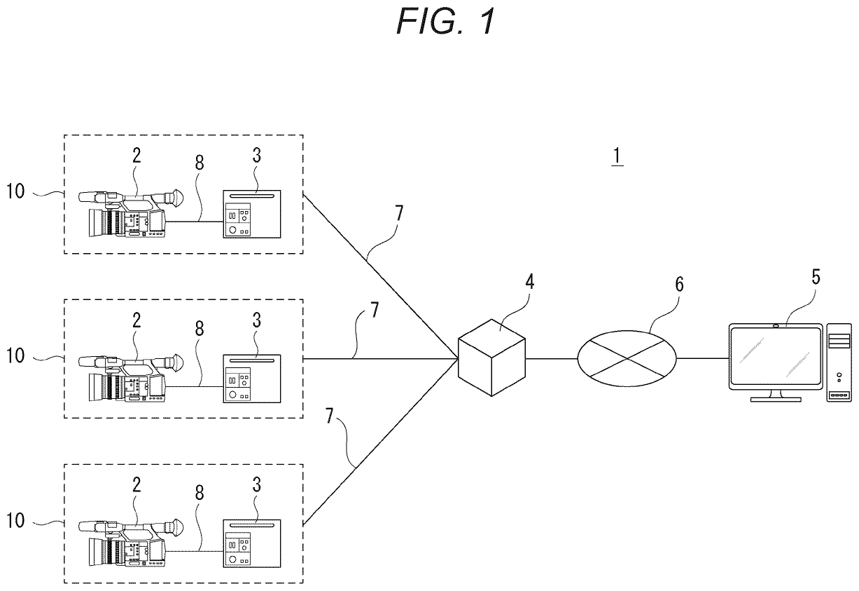

FIG. 1 illustrates a configuration example of a camera setting monitoring system 1 according to an embodiment. The camera setting monitoring system 1 provides a user interface (hereinafter, “UI”) for monitoring the setting values and operating the setting values in a broadcast station that operates a plurality of system cameras 10.

FIG. 1 illustrates the plurality of system cameras 10, a server device 4, and a terminal device 5. The system camera 10 includes a camera 2 and a camera control unit (hereinafter, CCU) 3. The camera 2 is a video camera for professional use, and outputs a captured video signal obtained by imaging to the CCU 3 through, for example, an optical fiber cable 8. The CCU 3 performs necessary processing on the captured video signal, and transmits the captured video signal to a switcher system or a recording device (not illustrated).

The captured video signals imaged by the plurality of system cameras 10 are selected in the switcher system to be a main line video signal, and are used for broadcasting and distribution or recorded in a recording medium.

In the case of using such a plurality of system cameras 10, the server device 4 provides a UI for monitoring and operation corresponding to, for example, a maximum of 96 system cameras 10. Note that the maximum 96 systems are an example.

Each system camera 10 and the server device 4 are communicably connected by a cable 7 constituting a local area network (LAN), for example. As a result, the server device 4 can acquire information of setting values of various setting items from each system camera 10, acquire detection information, and transmit operation information to each system camera 10.

A network 6 is assumed to be, for example, the Internet, but is not limited thereto, and may be formed as a home network, a LAN, a mobile communication network, or other networks.

The server device 4 can generate various screens described later as web pages, for example, and provide the screens to the terminal device 5 via the network 6.

The terminal device 5 includes an information processing device such as a personal computer (PC), a tablet device, or a smartphone.

The terminal device 5 can display a UI screen provided by the server device 4 by accessing the server device 4 via the network 6, for example, by a function of a WEB browser. The user of the terminal device 5 can monitor a setting value and the like of each system camera 10 and perform a variable operation of the setting value or the like on the UI screen.

Therefore, the video engineer can monitor the setting values and the like of the plurality of system cameras 10 and remotely operate the installation values and the like using the terminal device 5.

Note that the UI screen can be browsed by the plurality of terminal devices 5 performing WEB access with each of the plurality of terminal devices 5.

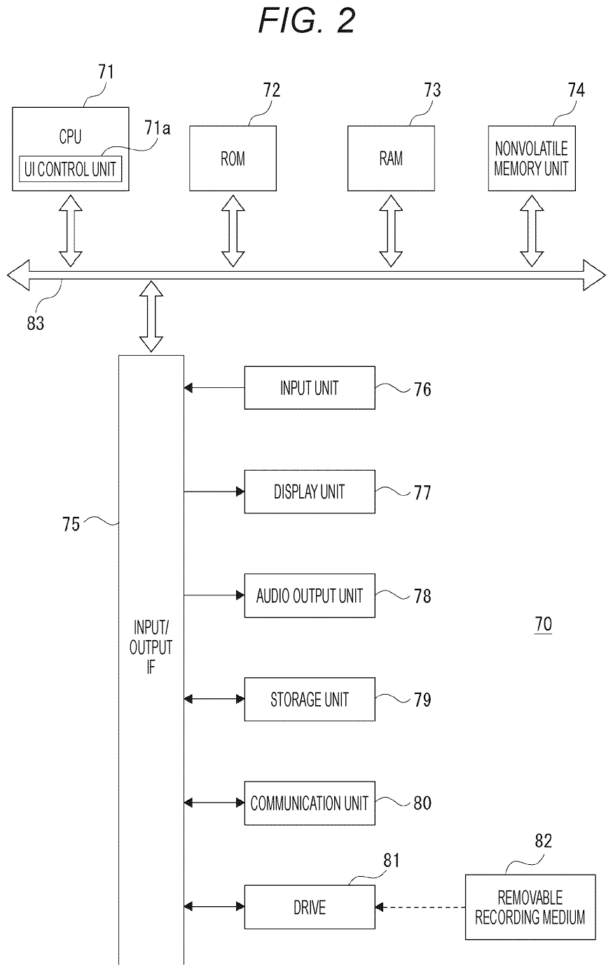

FIG. 2 illustrates a configuration of an information processing device 70 used as the server device 4. The information processing device 70 is a device capable of performing information processing, such as a computer device. Specifically, a microprocessor and a peripheral device, a personal computer, a workstation, a portable terminal device such as a smartphone or a tablet, and the like are assumed as the information processing device 70. Furthermore, the information processing device 70 may be a computer device configured as a server device or a calculation device in cloud computing.

A central processing unit (CPU) 71 of the information processing device 70 illustrated in FIG. 2 executes various types of processing in accordance with a program stored in a non-volatile memory unit 74 such as a read only memory (ROM) 72 or, for example, an electrically erasable programmable read only memory (EEP-ROM), or a program loaded from a storage unit 79 to a random access memory (RAM) 73. The RAM 73 also stores, as appropriate, data and the like necessary for the CPU 71 to perform the various types of processing.

The CPU 71 is provided with a UI control unit 71a as a function by software. The UI control unit 71a performs display control of various screens described later, that is, processing of generating and providing (transmitting) each screen as a web page, processing of responding to an operation input from the terminal device 5, and the like.

Specifically, the UI control unit 71a performs control to cause a list of setting values of setting items related to the plurality of system cameras 10 to be displayed, to perform difference determination processing of the setting values for each common setting item related to the plurality of system cameras 10, and to cause display according to the difference determination result to be executed together with displaying the list of the setting values.

Furthermore, the UI control unit 71a performs processing of causing time-series display of the setting values or the detection values related to the plurality of system cameras 10 to be executed.

Furthermore, the UI control unit 71a performs processing of causing a setting value panel indicating the setting item and the setting value for each of the plurality of system cameras 10 and a sub control panel commonly used to operate the setting values for the plurality of system cameras 10 to be displayed.

Note that instead of the CPU 71 or in addition to the CPU 71, a graphics processing unit (GPU), general-purpose computing on graphics processing units (GPGPU), an artificial intelligence (AI) processor, or the like may be provided.

The CPU 71, the ROM 72, the RAM 73, and the non-volatile memory unit 74 are connected to one another via a bus 83. Furthermore, an input/output interface 75 is also connected to the bus 83.

An input unit 76 including an operation element and an operation device is connected to the input/output interface 75. For example, as the input unit 76, various operation elements and operation devices such as a keyboard, a mouse, a key, a trackball, a dial, a touch panel, a touch pad, and a remote controller are assumed.

A user's operation is detected by the input unit 76, and a signal corresponding to the input operation is interpreted by the CPU 71.

A microphone is also assumed as the input unit 76. It is also possible to input voice uttered by the user as operation information.

Furthermore, a display unit 77 including a liquid crystal display (LCD), an organic electro-luminescence (EL) panel, and the like, and an audio output unit 78 including a speaker and the like are integrally or separately connected to the input/output interface 75.

The display unit 77 performs various displays. The display unit 77 includes, for example, a display device provided in a housing of the information processing device 70, a separate display device connected to the information processing device 70, or the like.

The display unit 77 displays various images, operation menus, icons, messages, and the like on the display screen, that is, as a GUI, on the basis of an instruction from the CPU 71.

In some cases, the storage unit 79 including a hard disk drive (HDD), a solid state drive (SSD), and the like, and a communication unit 80 are connected to the input/output interface 75.

The storage unit 79 can store various data and programs. A database can be configured in the storage unit 79.

The communication unit 80 performs communication processing via a transmission line such as the Internet, wired/wireless communication, bus communication, and the like with various devices such as an external database and an information processing device.

A drive 81 is also connected to the input/output interface 75, as necessary, and a removable recording medium 82 such as a magnetic disk, an optical disk, a magneto-optical disk, a semiconductor memory, or the like is appropriately mounted.

The drive 81 can read video data, various computer programs, and the like from the removable recording medium 82. The read data is stored in the storage unit 79, and video and audio included in the data are output by the display unit 77 and the audio output unit 78. Furthermore, the computer program and the like read from the removable recording medium 82 are installed in the storage unit 79, as necessary.

In the information processing device 70, for example, software for the processing in the present embodiment can be installed via network communication by the communication unit 80 or via the removable recording medium 82. Alternatively, the software may be stored in advance in the ROM 72, the storage unit 79, or the like.

Note that, although the configuration example of the information processing device 70 serving as the server device 4 has been described above, the information processing device 70 can function as the server device 4 without necessarily including all the illustrated components.

Furthermore, the information processing device 70 having such a configuration can also be applied as the terminal device 5. In the information processing device 70 serving as the terminal device 5, the function as the UI control unit 71a in the CPU 71 is not necessary, and the function as the WEB browser may be provided in the CPU 71.

### 2. USER INTERFACE SCREEN

### 2-1: Screen Transition

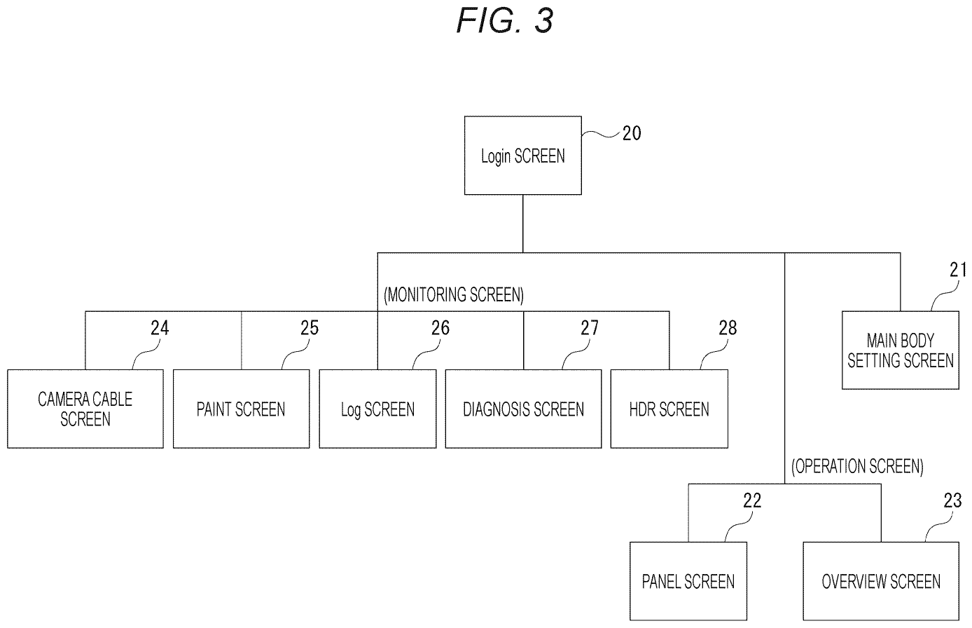

An example of a screen provided by the server device 4 and displayed on the terminal device 5 in the camera setting monitoring system 1 according to the embodiment will be described. FIG. 3 illustrates a transition of each screen.

For example, when the terminal device 5 accesses the server device 4 and starts WEB browsing, a login screen 20 is displayed as the first page. When the user logs in to the camera setting monitoring system 1 on the login screen 20, the screen can transition to another screen.

After logging in, the user can transition to a main body setting screen 21, an operation screen, and a monitoring screen. The description of the main body setting screen 21 is omitted.

The operation screen is a screen on which a user such as a video engineer can perform an operation of the setting value and the like of each system camera 10, and includes an operation panel screen 22 and an overview screen 23. Each screen is selected by tab operation.

The monitoring screen is a screen on which the user can monitor the setting value and the like of each system camera 10, and includes a camera cable screen 24, a paint screen 25, a log screen 26, a diagnosis screen 27, and a high dynamic range (HDR) screen 28. These screens are also selected by tab operation.

Hereinafter, a specific example of each screen will be described.

### 2-2: Operation Panel Screen

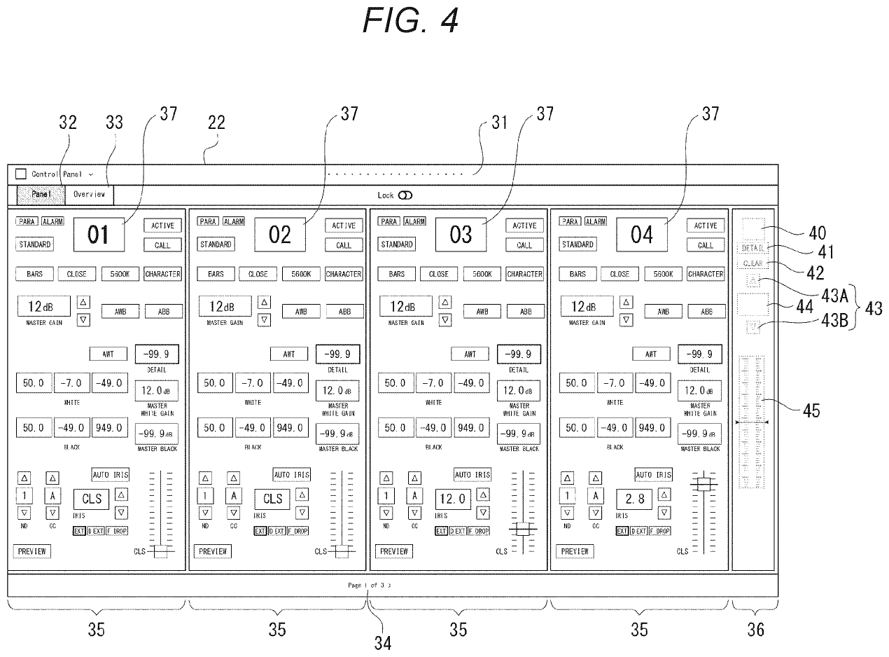

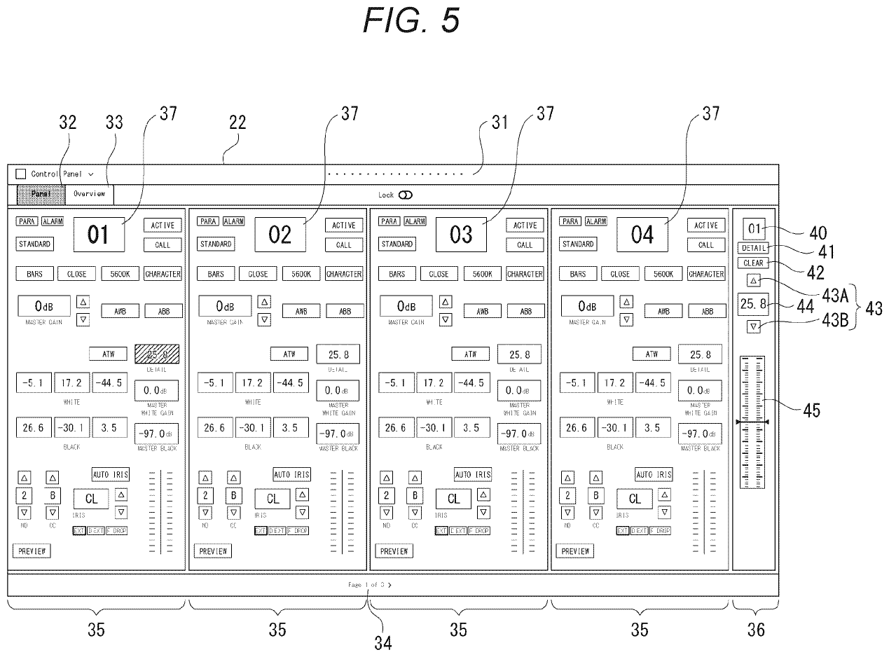

The operation panel screen 22, which is one of the operation screens, will be described. FIGS. 4 and 5 illustrate an example of the operation panel screen 22.

A message field 31 is prepared in the upper part of the screen. An error message and other messages are displayed in the message field 31. Note that the message field 31 is similarly provided in the upper part of other screens described later, and is used to display an error message and the like.

In the case of the operation screen, a panel tab 32 and an overview tab 33 are provided. The user can switch between the operation panel screen 22 and the overview screen 23 by these tab operations. FIGS. 4 and 5 illustrate a state in which the panel tab 32 is selected and the operation panel screen 22 is displayed. Note that the detailed description of the overview screen 23 is omitted.

On the operation panel screen 22, a setting value panel 35 corresponding to each system camera 10 is displayed. In the example of the drawing, for example, four setting value panels 35 are displayed corresponding to four system cameras 10 with camera numbers “01” to “04”. In the setting value panel 35 corresponding to the system camera 10 with the camera number “05” or later, the page is switched and displayed by the operation of the page feed button 34.

A camera number 37 is displayed on the setting value panel 35, and the corresponding system camera 10 is shown. On each setting value panel 35, various setting values related to the system camera 10 are displayed together with the setting item names. For example, “ACTIVE”, “CALL”, “MASTER GAIN”, “AWB”, “ABB”, “DETAIL”, and the like are displayed as the setting items, and numerical values and on/off states of these items are displayed.

Note that, in the present disclosure, the “setting value” is a value of various setting items, and the setting value includes not only a numerical value in a range having a certain degree of width but also a value (such as 0/1) indicating on/off of a mode, a function, or the like, a value indicating a mode type, a value indicating a status, and the like. That is, the numerical values and the states of the variably settable setting items of the system camera 10 are referred to as “setting values”.

For the setting items shown in the setting value panel 35, a user (video engineer) can variably operate the setting values. For example, an up/down button or the like is displayed in some setting items, so that the setting value can be changed by touching, clicking, or the like in the setting value panel 35. However, many setting items can be variably operated by a sub control panel 36.

As illustrated in FIGS. 4 and 5, the sub control panel 36 is displayed on the operation panel screen 22 together with the setting value panel 35.

Only one sub control panel 36 is provided so as to be compatible with the plurality of setting value panels 35 in common. Any one of the setting items of any one of the setting value panels 35 is assigned to the sub control panel 36. As a result, the operation of the assigned setting item can be executed on the sub control panel 36.

FIG. 4 illustrates a state in which no setting item is assigned to the sub control panel 36. The sub control panel 36 is displayed in an inactive state.

FIG. 5 illustrates a state in which setting items are assigned to the sub control panel 36. For example, FIG. 5 illustrates a state in which, when the user clicks or taps on “DETAIL” of the camera number “01”, the setting value of “DETAIL” of the camera number “01” is assigned to the sub control panel 36, and a variable operation of the setting value can be performed.

Selection by the user causes a display mode of “DETAIL” in the setting value panel 35 of the camera number “01” to be a mode different from other setting items. Although hatched in the drawing, the color is changed or highlighted, for example, blue is displayed.

Furthermore, “DETAIL” of the camera number “01” is indicated on the sub control panel 36.

A camera number 40, an item name 41, a clear button 42, an up/down button 43, a current value 44, and an adjuster 45 are displayed on the sub control panel 36.

The selected camera number (“01” in this example) is displayed as the camera number 40, and the setting item (“DETAIL” in this example) selected as the item name 41 is displayed.

The clear button 42 is an operation element that clears the setting value of the assigned setting item, that is, returns the setting value to zero or an initial value.

The current setting value of the assigned setting item is displayed by the current value 44.

The up/down button 43 includes an up button 43A and a down button 43B, and is an operation element that changes a setting value up and down. One click of the up button 43A or the down button 43B changes the setting value up and down in the minimum unit of the assigned setting item. It is also possible to greatly change the value by long-pressing the up button 43A or the down button 43B. For example, the change amount can be increased in an acceleration manner according to the long press time.

The adjuster 45 is an operation element that is displayed so as to indicate a current value on a gauge, and can variably operate a setting value with a control width optimized for each setting item by turning a wheel to which the gauge is attached. For example, when the terminal device 5 is a tablet device, the adjuster 45 can be operated by finger scrolling, and when the terminal device 5 is a PC, the adjuster 45 can be operated by a mouse. The mouse operation also corresponds to a plurality of operations such as a wheel and hold and drop.

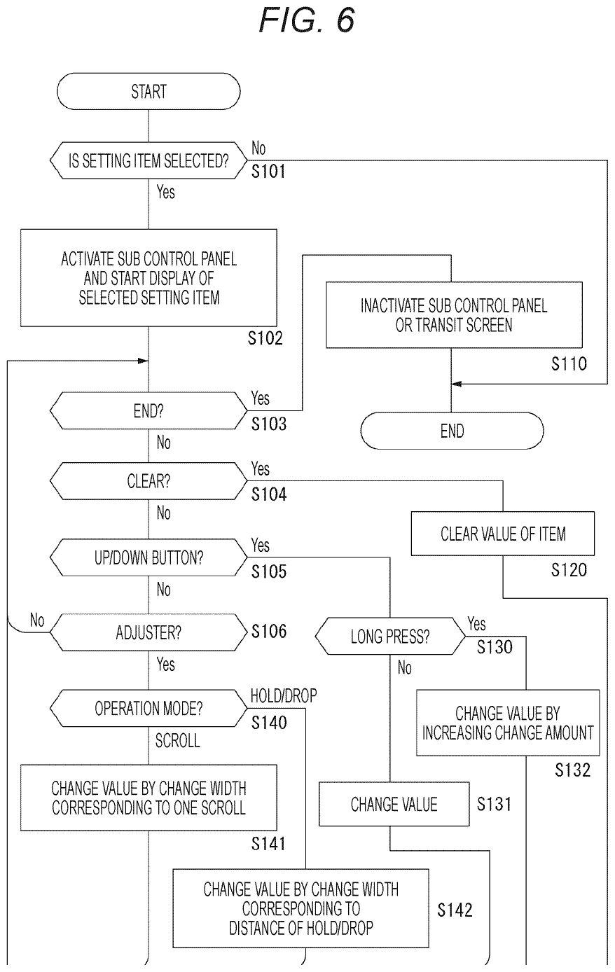

FIG. 6 illustrates a processing example of the CPU 71 of the server device 4 related to the operation of the sub control panel 36. This processing example is a processing example executed by the CPU 71 by the function of the UI control unit 71a.

In step S101, the CPU 71 (UI control unit 71a) determines whether or not any setting item in any setting value panel 35 is selected by a user operation. When the setting item is not selected, the process of FIG. 6 ends. The sub control panel 36 is in an inactive state.

In a case where a certain setting item is selected in a certain setting value panel 35, the CPU 71 proceeds from step S101 to step S102, and performs control to activate the sub control panel 36 and assign the selected system camera 10 and the setting item. Then, control is performed to cause display related to the selected system camera 10 and the setting item to be executed in the sub control panel 36. That is, the camera number 40, the item name 41, and the current value 44 are displayed corresponding to the selected system camera 10 and the setting item.

In a state where the sub control panel 36 is in an active state, the CPU 71 performs monitoring processing in steps S103, S104, S105, and S106.

In a case where it is detected that the user has operated the clear button 42, the CPU 71 proceeds from step S104 to step S120, performs processing of clearing the setting value of the assigned setting item, and causes the display of the current value 44 to be changed to the cleared new value.

In a case where it is detected that the user has operated the up/down button 43, the CPU 71 proceeds from step S105 to step S130 and determines the operation mode. In this case, the CPU 71 determines whether the up button 43A or the down button 43B is pressed for a long time or for a short time.

In the case where the up button 43A or the down button 43B is pressed for a short time, the CPU 71 proceeds to step S131, performs processing of changing the setting value by one unit to up or down, and also causes the display of the current value 44 to be changed.

In a case where the up button 43A or the down button 43B is pressed for a long time, the CPU 71 proceeds to step S132, performs processing of changing the setting value by increasing the change amount, and also causes the display of the current value 44 to be changed accordingly. In the case of the long press, the setting value may be changed for each specific unit having a certain width during a period in which the long press is continued, or the change width may be increased in an acceleration manner according to the long press period.

In a case where it is detected that the user has operated the adjuster 45, the CPU 71 proceeds from step S106 to step S140 and determines the operation mode. In this case, the CPU 71 determines whether the operation is a scroll operation or a hold/drop operation.

In the case of the scroll operation, the CPU 71 proceeds to step S141, performs processing of changing the setting value by a change width corresponding to the scroll operation, and also causes the display of the current value 44 to be changed. For example, in the case of the scroll operation, although depending on the setting of the mouse or the like on the terminal device 5 side, one to three memory movements are made with respect to one scroll.

The hold/drop operation is an operation of moving a mouse with holding the mouse and then dropping the mouse. In the case of the hold/drop operation, the CPU 71 proceeds to step S142, performs processing of changing the setting value by increasing the change amount corresponding to the distance from the hold to the drop, and also causes the display of the current value 44 to be changed accordingly. For example, when the user moves the gauge of the adjuster 45 from the top to the bottom, the setting value is changed with a change width such that the gauge moves from 20 to 30 marks.

In a case where the user performs an operation of clicking again the setting item selected on the setting value panel 35 or performs an operation of transitioning to another screen, the operation is an end operation of the sub control panel 36.

In a case where the end operation is detected, the CPU 71 proceeds from step S103 to step S110, and performs control to inactivate the sub control panel 36. Alternatively, the screen is transited to another screen.

According to the processing of FIG. 6 described above, the user selects a setting item of the system camera 10 to be operated, and moves the up/down button 43 in the sub control panel 36 and the wheel of the adjuster 45 so as to rotate, whereby the setting value can be finely adjusted.

Therefore, the user can variably set setting values of the plurality of system cameras 10 with the operation panel screen 22 by remote operation from the terminal device 5.

### 2-3: Camera Cable Screen

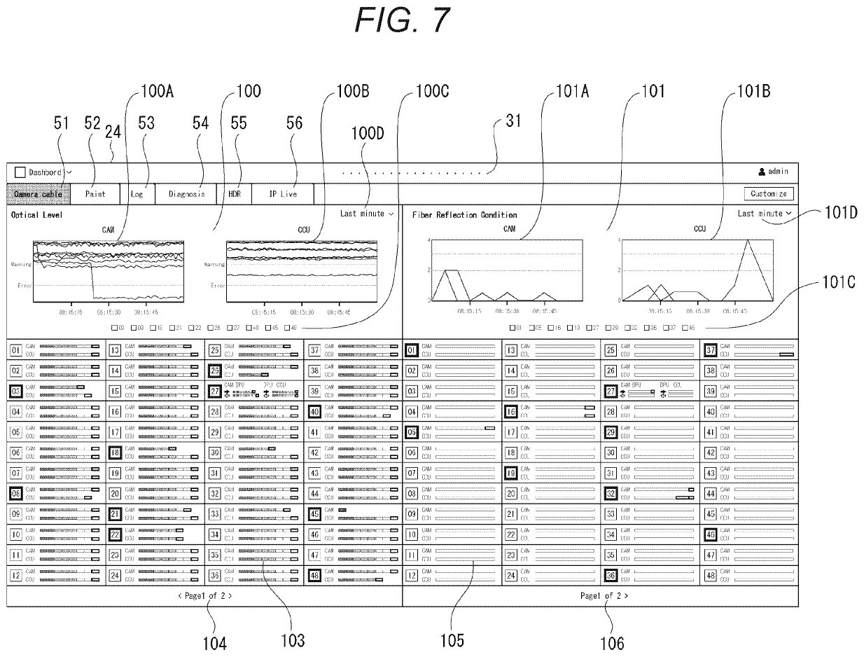

Next, an example of the camera cable screen 24, which is one of the monitoring screens, is illustrated in FIG. 7.

Note that, in the monitoring screen described below, as illustrated in FIG. 7, a camera cable tab 51, a paint tab 52, a log tab 53, a diagnosis tab 54, an HDR tab 55, and an IP live tag 56 are prepared, and screen transition is performed by selecting these tabs.

FIG. 7 illustrates a state in which the camera cable tab 51 is selected and the camera cable screen 24 is displayed.

The camera cable screen 24 is a screen for monitoring the communication quality by the optical fiber cable 8 between the camera 2 and the CCU 3. A decrease in the quality of communication leads to a broadcasting accident such as image disturbance, and thus, it is preferable to collectively monitor the plurality of system cameras 10.

The camera cable screen 24 is provided with a light reception level time-series area 100, a light reflection time-series area 101, a light reception level current value area 103, and a light reflection current value area 105.

In the light reception level time-series area 100, the light reception level of the optical signal transmitted through the optical fiber cable 8 of each system camera 10 is indicated by time-series graphs 100A and 100B.

Furthermore, in the light reception level current value area 103, the current value of the light reception level of the optical signal of each system camera 10 is indicated in the form of, for example, a bar graph indicator.

For example, in the light reception level current value area 103, the current values of the light reception levels of the 48 system cameras 10 with the camera numbers “01” to “48” are displayed. The page of the current value of the system cameras 10 with the camera numbers “49” to “96” is switched by the operation of the page feed button 104.

In this light reception level current value area 103, the light reception levels of the camera 2 side (CAM in the drawing) and the CCU 3 side (CCU in the drawing) are indicated by indicators corresponding to the camera numbers. Then, a graph indicating the time-series change in the light reception level is displayed in the light reception level time-series area 100 for the system camera 10 with the camera number (indicated by a thick line frame in the drawing) highlighted among the camera numbers.

When the user selects (highlights) the camera number in the light reception level current value area 103, the graph of the system camera 10 with the camera number can be displayed in the time-series graphs 100A and 100B.

In the light reception level time-series area 100, the time-series graph 100A of the light reception level on the camera 2 side and the time-series graph 100B of the light reception level on the CCU 3 side are each indicated. In order to display the light reception level of each system camera 10, actually, for example, a color corresponding to the camera number is set. For example, as a legend 100C, the camera number and the color are displayed in correspondence with each other, and the lines of the time-series graphs 100A and 100B are displayed in the respective colors. Note that the graph display of each system camera 10 may be distinguished in other display modes such as using different types of lines instead of colors.

Note that time widths of the time-series graphs 100A and 100B can be variably set by the operation of a time setting unit 100D.

In the light reflection time-series area 101, time-series graphs 101A and 101B of the light reflection state (the number of errors) by the transmission through the optical fiber cable 8 of each system camera 10 are indicated.

Furthermore, in the light reflection current value area 105, the current value of the light reflection state of the optical signal of each system camera 10 is indicated in the form of, for example, a bar graph indicator.

For example, in the light reflection current value area 105, the current values of the light reception levels of the 48 system cameras 10 with the camera numbers “01” to “48” are displayed. The page of the current value of the system cameras 10 with the camera numbers “49” to “96” is switched by the operation of the page feed button 106.

In this light reflection current value area 105, the light reflection current values of the camera 2 side (CAM in the drawing) and the CCU 3 side (CCU in the drawing) are indicated by indicators corresponding to the camera numbers. Then, a graph indicating a time-series change in light reflection of the system camera 10 with the camera number (indicated by a thick line frame in the drawing) highlighted among the camera numbers is displayed in the light reflection time-series area 101.

When the user selects (highlights) the camera number in the light reflection current value area 105, the graph of the system camera 10 with the camera number can be displayed in the time-series graphs 101A and 101B.

In the light reflection time-series area 101, the time-series graph 101A of the light reflection state on the camera 2 side and the time-series graph 101B of the light reflection state on the CCU 3 side are indicated. In order to display the light reflection state of each system camera 10, for example, a color corresponding to the camera number is set. For example, as a legend 101C, the camera number and the color are displayed in correspondence with each other, and the lines of the time-series graphs 101A and 101B are displayed in the respective colors. Note that the graph display of each system camera 10 may be distinguished in other display modes such as using different types of lines instead of colors.

Note that time widths of the time-series graphs 101A and 101B can be variably set by the operation of the time setting unit 101D.

As described above, on the camera cable screen 24, the parameters related to the communication quality of each system camera 10 can be monitored in the time-series graph together with the current values.

### 2-4: Paint Screen

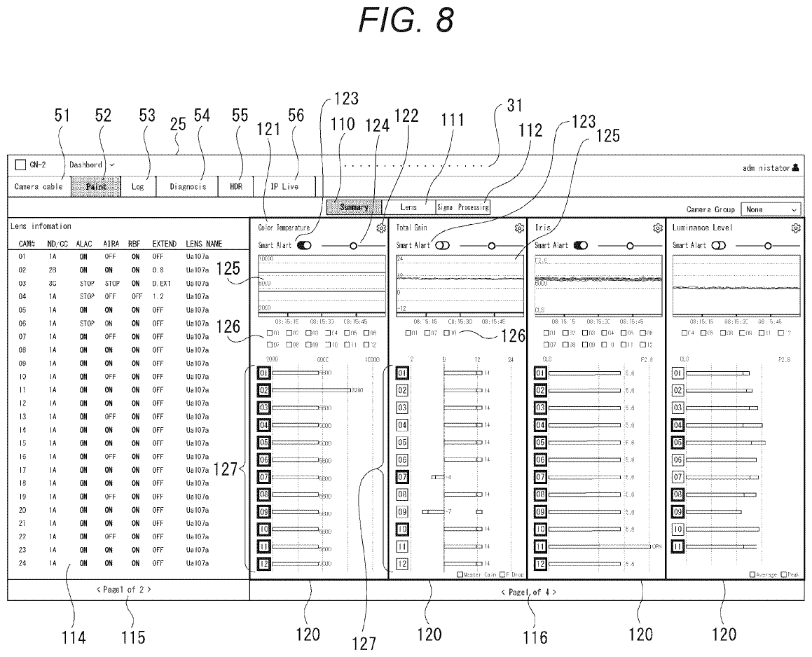

Next, the paint screen 25 will be described with reference to FIGS. 8 to 13. The paint screen 25 is a screen that lists and can monitor setting values related to image creation of the system camera 10. In particular, it is suitable for a comparison list of the plurality of system cameras 10.

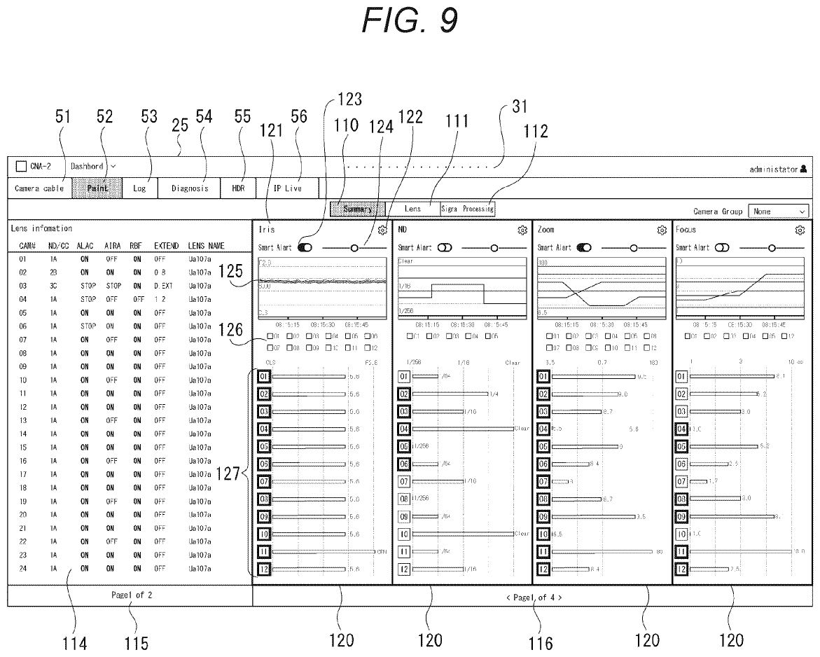

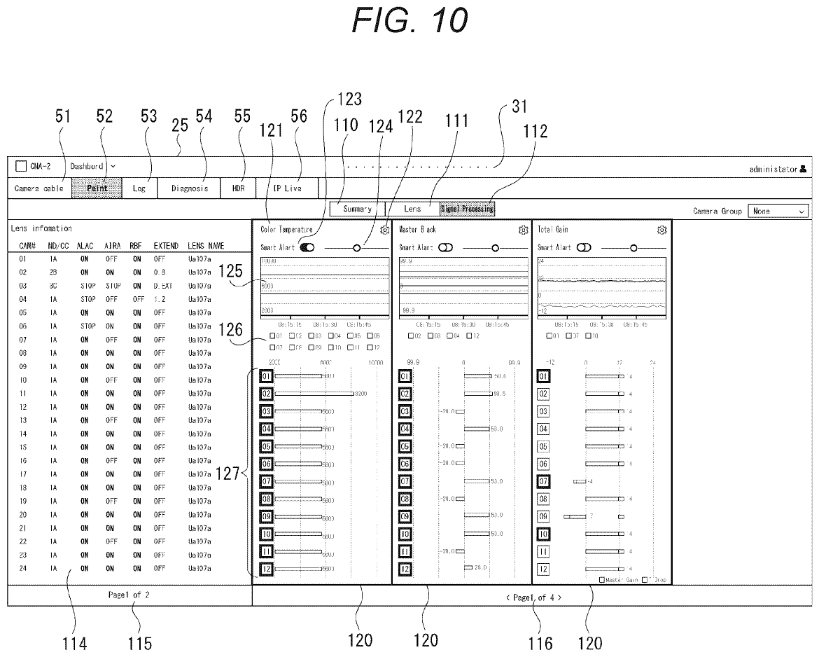

FIGS. 8, 9, and 10 illustrate a state in which the paint tab 52 is selected and the paint screen 25 is displayed. On the paint screen 25, a summary tab 110, a lens tab 111, and a signal processing tab 112 are prepared, and FIG. 8 illustrates a screen of the summary tab 110, FIG. 9 illustrates a screen of the lens tab 111, and FIG. 10 illustrates a screen of the signal processing tab 112.

For example, in the summary tab 110 in FIG. 8, setting items such as color temperature (Color Temperature), total gain (Total Gain), iris (Iris), and luminance level (Luminance Level) are displayed as main setting items.

In the lens tab 111 in FIG. 9, setting items such as iris (Iris), ND filter (ND), zoom (Zoom), and focus (Focus) are displayed as setting items related to the lens.

In the signal processing tab 112 in FIG. 10, setting items such as color temperature (Color Temperature), master black (Master Black), and total gain (Total Gain) are displayed as setting items related to signal processing.

On these paint screens 25, a lens information area 114 and a setting value box 120 for each setting item described above are displayed.

In the lens information area 114, a list of information regarding the lens for each system camera 10 is displayed. For example, setting values (on/off or the like) related to setting items such as “ND/CC”, “ALAC”, “AIRA”, and “RBF”, lens names, and the like are displayed in correspondence with the camera numbers “01” to “24”.

Information regarding the lens of the system camera 10 with the camera number “25” or later is also displayed by operating a page feed button 115.

In the setting value box 120, a list of setting values of the system cameras 10 for each setting item is displayed. In FIG. 8, a setting value box 120 is provided for each of the color temperature, the total gain, the iris, and the luminance level described above.

In each setting value box 120, a setting value name 121, a detailed setting button 122, a smart alert button 123, a threshold slider 124, a setting value time-series area 125, a legend 126, and a setting value current value area 127 are displayed.

The setting value name 121 indicates the names of setting items such as color temperature, total gain, iris, and luminance level.

Then, in the setting value current value area 127, a list of the setting values of the system cameras 10 for the setting items is displayed. In FIGS. 8, 9, and 10, a list of the setting values of the camera numbers “01” to “24” is displayed. The setting values of the system camera 10 with the camera number “25” or later are also displayed by operating the page feed button 116.

In the setting value time-series area 125, the setting value of each system camera 10 is displayed in a time-series graph. The legend 126 indicates, for example, a display mode such as a color and a line type for each system camera 10, and in the time-series graph, each system camera 10 is distinguished by the display mode.

Here, the setting value box 120 has a different display method according to whether a smart alert function is turned on or off. The smart alert function is turned on/off by an operation of the smart alert button 123. FIG. 8 illustrates an example in which the smart alert function is turned on in the setting value boxes 120 of the color temperature (Color Temperature) and the iris (Iris), and the smart alert function is turned off in the setting value boxes 120 of the total gain (Total Gain) and the luminance level (Luminance Level).

Note that the detailed setting button 122 is an operation element for performing detailed setting of the smart alert function and the setting value time-series area 125, and the threshold slider 124 is an operation element for setting the sensitivity of the smart alert function.

First, a case where the smart alert function is turned off will be described. For example, focusing is on the setting value box 120 of the total gain in FIG. 8.

In this case, in the setting value current value area 127, the value of the total gain is indicated by a bar graph indicator corresponding to the camera numbers “01” to “12” of the system camera 10.

Then, a graph indicating a time-series change in the setting value of the camera number (indicated by a thick line frame in the drawing) highlighted among the camera numbers is displayed in the setting value time-series area 125.

For example, in the setting value box 120 of the total gain in FIG. 8, the time-series graph of the total gain of the system camera 10 with the camera numbers “01”, “07”, and “10” is displayed in the setting value time-series area 125.

In order to display the total gain of each system camera 10, for example, a color corresponding to the camera number is set, and the camera number and the color are displayed in association with each other in the legend 126. The lines of the time-series graph in the setting value time-series area 125 are displayed in respective colors. Note that the graph display of each system camera 10 may be distinguished in other display modes such as using different types of lines instead of colors.

Therefore, the user can cause the graph for the system camera 10 with the camera number to be displayed as the graph in the setting value time-series area 125 by selecting (highlighting) the camera number in the setting value current value area 127.

The smart alert function is a function of dynamically comparing and analyzing setting values of a plurality of system cameras 10, and detecting and notifying, in real time, a system camera 10 having a setting value significantly different from other system cameras. By automating the comparison and the monitoring of the setting values, the system camera 10 having different image creation settings can be found at an early stage, and the operation can be made efficient.

Although the smart alert function will be described in detail later, first, a display example in a case where the smart alert function is turned on will be described focusing on the setting value box 120 of the color temperature in FIG. 8.

In the setting value box 120 of the color temperature, in the setting value current value area 127, the value of the color temperature is indicated by a bar graph indicator corresponding to the camera numbers “01” to “12” of the system camera 10. In this case, all the camera numbers are highlighted, indicating that all the system cameras 10 are monitoring targets in the smart alert function. Note that some of the system cameras 10 can be set as monitoring targets. For example, when the user designates a camera number that does not require monitoring and cancels highlight, the system camera 10 can be excluded from the target of the smart alert function.

In the setting value current value area 127, when the setting value is significantly different, the bar graph is displayed in a display mode different from the other bar graphs, such as a color different from the others, as an alert. For example, a state is illustrated in the drawing in which since the color temperature of the camera number “02” is significantly different from the others, an alert is displayed.

The camera numbers targeted in the setting value current value area 127, for example, a graph indicating the time-series change in the setting values of all the system cameras 10, are displayed in the setting value time-series area 125.

In this case, among the camera numbers “01” to “12”, the setting values of the color temperature are equivalent values except for “02”, and a common display mode (for example, color) is indicated in the legend 126, and different modes (for example, different colors) are indicated for “02”. Then, the line of the time-series graph in the setting value time-series area 125 is displayed in the mode (for example, color) indicated by the legend 126. Since the values other than “02” are the same, they are collectively displayed by one line.

In a case where the smart alert function is turned on in this manner, display is performed such that the system camera 10 having setting values significantly different from the other setting values can be compared with the setting values of the majority in time series.

Note that, although different depending on the setting item, the equivalent value includes not only a value in which the setting value completely matches but also a value that can be evaluated as equivalent. The equivalent range also changes according to the sensitivity setting by the threshold slider 124. Then, an alert is displayed for the system camera 10 having a value (outlier) that is not equivalent.

The smart alert function will be described.

At the time of switching the system cameras 10 in the switcher on the air, the image creation settings of the system cameras 10 need to be matched so that a sense of discomfort does not appear on the screen of the main line video. However, since it is necessary to finely adjust the setting value in real time according to the angle of view or the subject, it is not sufficient to perform the simultaneous operation. Furthermore, it is not sufficient that the setting values completely match. Then, since the appropriate setting value varies according to the subject, the “abnormal value” and the “normal value” cannot be statically defined. Therefore, the smart alert function is mounted as a function of dynamically comparing and analyzing the setting values for the plurality of system cameras 10.

For example, the smart alert function can be selected for each setting item of the iris, the color temperature, the ND filter, the master black, the total gain, the luminance level (peak), and the luminance level (average).

For these setting items, the user can activate the smart alert function related to the setting item by operating the smart alert button 123 in each setting value box 120.

Furthermore, the user can select the target system camera 10 by selecting the camera number in the setting value current value area 127 as described above. For example, when the smart alert function is turned on, all the camera numbers may be in a selected state or all the camera numbers may be in an unselected state by default.

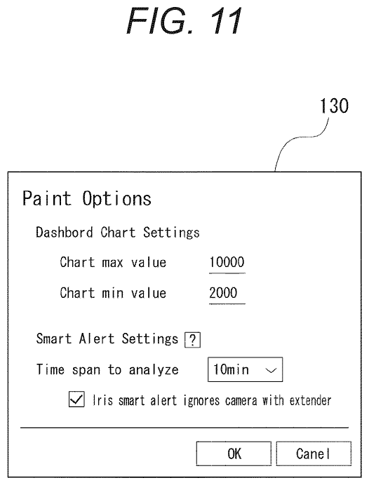

Furthermore, detailed settings can be made on the detailed setting screen from the detailed setting button 122. For example, a detailed setting screen 130 of FIG. 11 is displayed by operating the detailed setting button 122.

The detailed setting screen 130 allows the user to set a time width (Time span analyze) of data to be used for analysis.

Furthermore, on the detailed setting screen 130, as a unique option setting of the system camera 10, a setting such as excluding a camera having an extender in the smart alert function of the iris can be made.

Note that, on the detailed setting screen 130, the range of the vertical axis of the graph of the setting value time-series area 125 can be set as the chart maximum value (Chart max value) and the chart minimum value (Chart min value).

Furthermore, regarding the smart alert function, the user can set a threshold (sensitivity) of clustering by the threshold slider 124. The threshold is a threshold for outlier determination in the smart alert function. The distance between feature amount data can be set by the threshold slider 124, and the smaller the threshold, the stricter the outlier determination. That is, even if the deviation is small, it is easily determined to be an outlier, and an alert is easily issued.

In a case where the alert is excessively issued, the user can lower the sensitivity by adjusting the threshold slider 124.

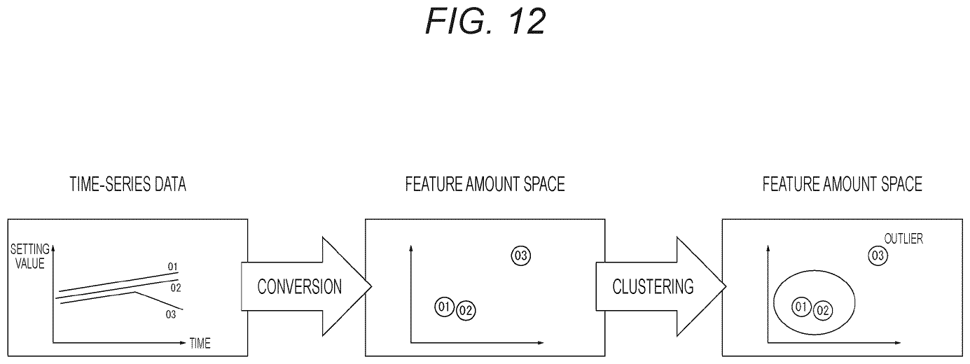

Analysis by the smart alert function is performed as illustrated in FIG. 12.

First, time-series data is acquired for each system camera 10 for the setting value of a setting item for which the smart alert function is turned on, such as the color temperature or the luminance level. FIG. 12 illustrates time-series data of the camera numbers “01”, “02”, and “03”.

The time-series data of each system camera 10 is converted into a feature amount space. Then, clustering is performed in the feature amount space to determine the system camera 10 having an equivalent setting value. The range of clustering (the distance of the feature amount) is expanded or contracted by the setting of the threshold slider 124 described above. Then, a setting value outside the range of the equivalent setting value is detected as an outlier. For such outliers, an alert is displayed in the setting value current value area 127, and a graph different from the others is displayed in the setting value time-series area 125.

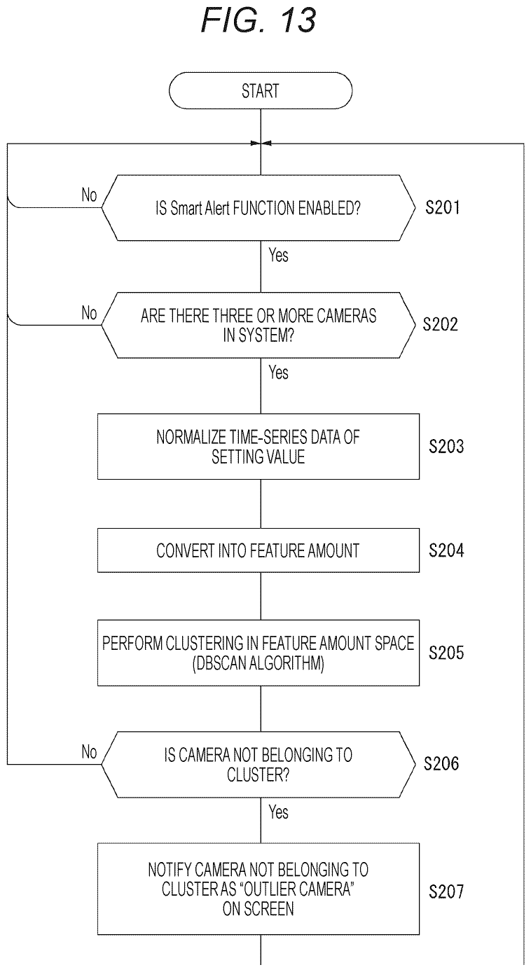

FIG. 13 illustrates a processing example of the CPU 71 of the server device 4 related to the smart alert function. This processing example is a processing example executed by the CPU 71 for each setting value box 120 with the function of the UI control unit 71a.

Regarding one setting value box 120, the CPU 71 (the UI control unit 71a) checks whether or not the smart alert function is enabled in step S201. If the smart alert function is not enabled, the CPU 71 does not perform processing related to the smart alert function.

If the smart alert function is enabled, the CPU 71 checks, in step S202, whether or not there are three or more cameras 2 (the system cameras 10) in the camera setting monitoring system 1. This is because there is no meaning of the smart alert function for detecting an outlier unless there are three or more cameras. In a case where there are one or two cameras, the CPU 71 does not perform processing related to the smart alert function.

Note that even in a case where there are three or more system cameras 10, when there are not three or more system cameras 10 to be processed by the smart alert function, that is, when three or more system cameras 10 are not selected in the setting value current value area 127, the CPU 71 exits the processing from step S202 and does not perform the processing related to the smart alert function.

In a case where the smart alert function is turned on by the operation of the smart alert button 123 and there are three or more target system cameras 10, the CPU 71 proceeds to step S203 and executes processing of the smart alert function.

In step S203, the CPU 71 acquires and normalizes time-series data of the setting value of the setting value box 120. For example, in the case of processing for the setting value box 120 of the color temperature, the CPU 71 acquires time-series data of the color temperature setting value for each system camera 10 and normalizes the time-series data.

In step S204, the CPU 71 converts the time-series data of each system camera 10 into a feature amount.

In step S205, the CPU 71 performs clustering in the feature amount space. In this case, clustering can be performed by, for example, a density based spatial clustering of applications with noise (DBSCAN) algorithm.

In step S206, the CPU 71 determines whether or not there is a system camera 10 having a setting value that does not belong to a cluster.

If not, it means that there is no system camera 10 having a setting value that is an outlier, and the outlier is not displayed.

On the other hand, in a case where there is a system camera 10 having a setting value that does not belong to the cluster, the CPU 71 proceeds to step S207, and causes display clearly indicating the system camera 10 having a setting value that is an outlier to be executed. For example, as illustrated in FIG. 8, the color temperature setting value for the system camera 10 with the camera number “02” is displayed in a different color or the like, which means an alert.

When the above processing is performed for each setting value box 120, in the setting value box 120 in which the smart alert function is turned on, a setting value different from the setting values of the other system cameras 10 is displayed as an alert, and it is possible to allow the user to easily recognize the system camera 10 that is not aligned with the others in terms of image creation.

As described above, on the paint screen 25, graphical (time-series graph, bar graph) visualization of the setting values related to image creation is realized. The specifications specific to the system camera 10 such as the color temperature, the total gain, and the iris are reflected in the graph display specification. Moreover, the smart alert function clearly indicates the system camera 10 having a setting value that is not matched with the others.

As described above, the paint screen 25 is a screen extremely suitable for monitoring installation values and outliers regarding image creation of the plurality of system cameras 10.

### 2-5: Log Screen

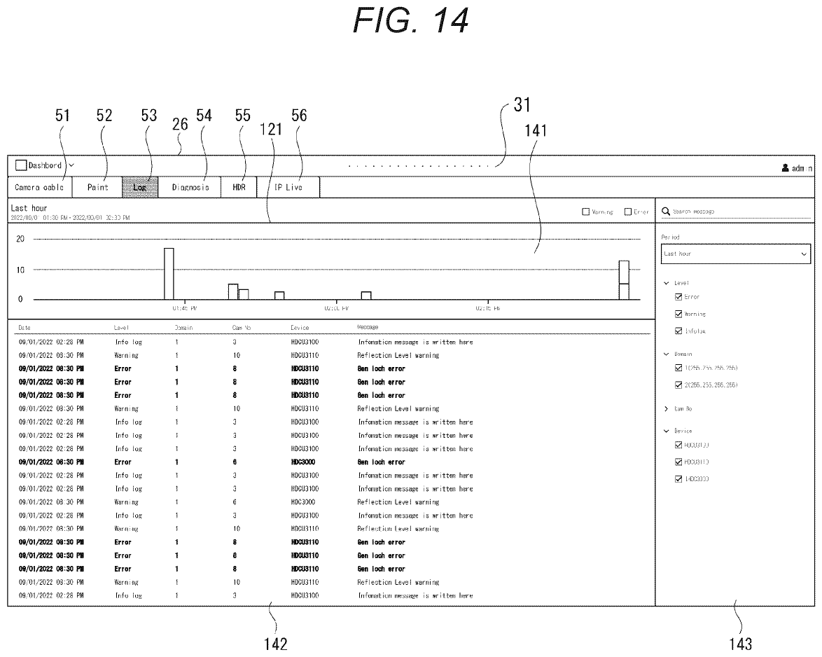

An example of the log screen 26 is illustrated in FIG. 14. This is a screen on which the logs of the system cameras 10 are collectively displayed. FIG. 14 illustrates a state in which the log tab 53 is selected and the log screen 26 is displayed.

On the log screen 26, a log time-series area 141, a log list area 142, and a setting area 143 are provided.

In the log list area 142, a list of logs related to errors, warnings, notifications, and the like that have occurred in all the system cameras 10 in the camera setting monitoring system 1 is displayed.

Furthermore, in the log time-series area 141, the generated log is displayed on the time axis. In this case, the vertical axis represents the number of logs, and the horizontal axis represents time, which are displayed in the form of a bar graph on the time axis.

The setting area 143 is an area where settings related to the log display can be made.

On such a log screen 26, logs that have been able to be checked only for each system camera 10 so far can be collectively checked for the plurality of system cameras 10. Furthermore, the log generation time can be checked in time series. Therefore, the screen is extremely suitable for the user to monitor the log for each system camera 10.

### 2-6: Diagnosis Screen

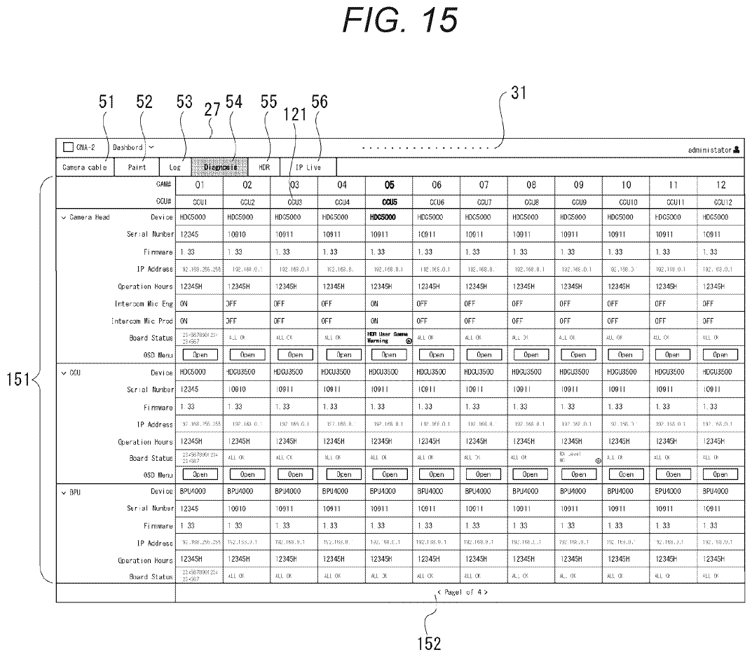

FIG. 15 illustrates an example of a diagnosis screen 27. This is a screen listing static information of each system camera 10. FIG. 15 illustrates a state in which the diagnosis tab 54 is selected and the diagnosis screen 27 is displayed.

A list area 151 is provided on the diagnosis screen 27. In the list area 151, camera numbers are arranged in the horizontal direction, and names of static information are arranged in the vertical direction.

Then, for the system camera 10 of each camera number, information such as a device, a serial number, firmware, and an IP address is displayed as information regarding the camera head, the CCU, and the baseband processor unit (BPU).

Note that, although not illustrated in FIG. 1, the BPU is a unit that may be provided together with the camera 2 and the CCU 3 in the system camera 10 for 4K camera signal processing or the like, for example.

In FIG. 15, information of the system cameras 10 with the camera numbers “01” to “12” is displayed in the list area 151. The information of the system camera 10 with the camera number “13” or later is displayed on another page by operating the page feed button 152.

The diagnosis screen 27 allows the user to collectively check the information of the plurality of system cameras 10, which is suitable for various confirmation for operation.

### 2-7: HDR Screen

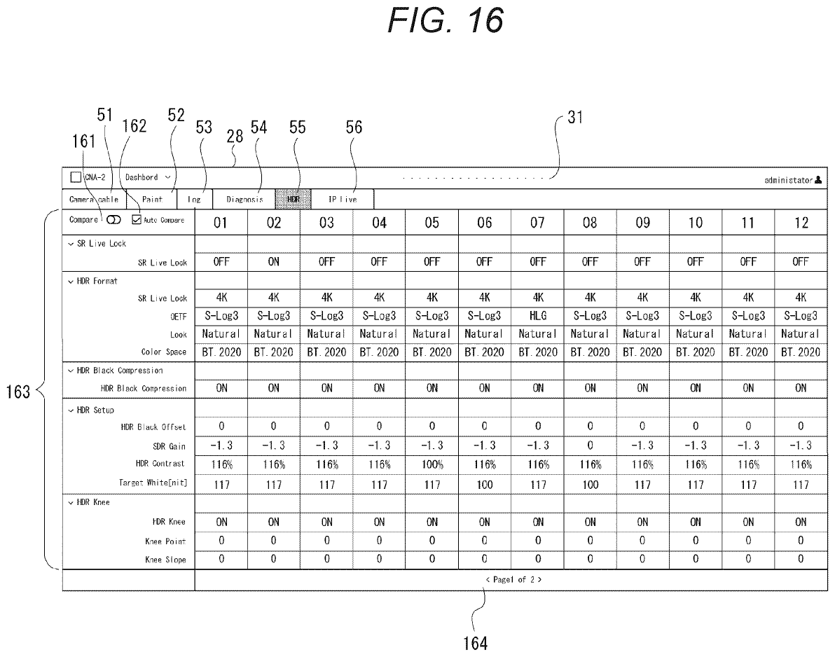

An HDR screen 28 will be described with reference to FIGS. 16, 17, and 18. The HDR screen 28 is a screen for listing dedicated setting values in a case where the system camera 10 is operated in high dynamic range (HDR).

In particular, unlike the paint screen 25, the HDR screen 28 is a screen for confirming that the setting values completely match before operation.

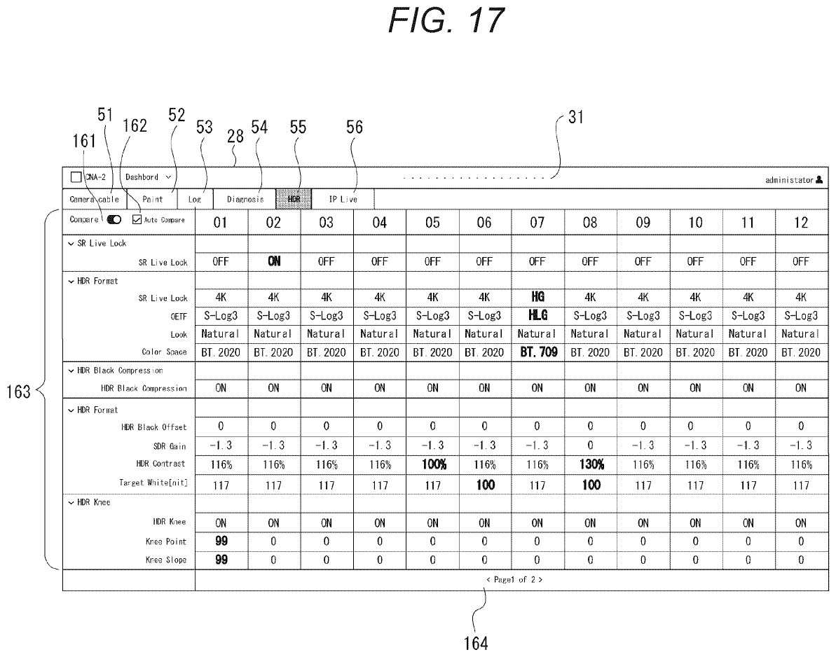

FIGS. 16 and 17 illustrate screen examples. FIG. 16 illustrates a state in which a compare function is turned off, and FIG. 17 illustrates a state in which the compare function is turned on and auto compare is turned on.

On the HDR screen 28, a compare button 161, an auto compare box 162, a list area 163, and a page feed button 164 are displayed.

In the list area 163, camera numbers are arranged in the horizontal direction, and names of various setting values are arranged in the vertical direction. Then, various setting values are displayed for the system camera 10 of each camera number. For example, setting values such as “SR Live Lock”, “HDR Format”, “HDR Black Compression”, “HDR Setup”, and “HDR Knee” are used.

Note that, in FIGS. 16 and 17, information of the system cameras 10 with the camera numbers “01” to “12” is displayed in the list area 163. The information of the system camera 10 with the camera number “13” or later is displayed on another page by operating the page feed button 164.

The user can confirm that the setting values of the system cameras 10 are unified by the list area 163.

For example, the user can simply visually check the list area 163 to confirm the consistency of the setting values, but can more easily check by turning on the compare function or further enabling the auto compare function.

The compare function is turned on when the user operates the compare button 161. Furthermore, when the auto compare box 162 is further checked, the auto compare function is turned on.

The compare function is a function of highlighting a setting value different from a setting value of the system camera 10 when the user selects the system camera 10 to be a reference.

The auto compare function is a function of automatically highlighting a setting value that does not belong to a majority group by taking a majority decision for each setting item even when the user does not set the system camera 10 as a reference.

For example, FIG. 17 illustrates a state in which the auto compare function is turned on, and a state in which some of the setting values are highlighted in the list area 163.

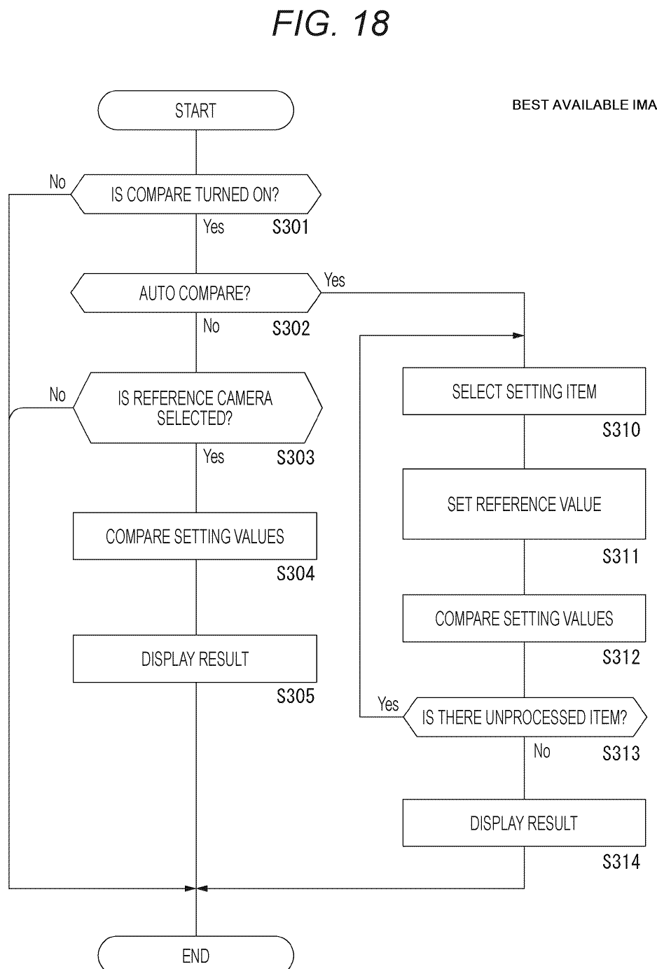

FIG. 18 illustrates a processing example of the CPU 71 of the server device 4 for the compare function and the auto compare function. This processing example is a processing example executed by the CPU 71 by the function of the UI control unit 71a.

In step S301, the CPU 71 (the UI control unit 71a) branches the process according to whether or not the compare function is turned on. In a case where the user instructs the compare function using the compare button 161, the compare function is turned on.

In step S302, the CPU 71 further checks whether or not the auto compare function is selected, that is, whether or not the auto compare box 162 is checked.

If the auto compare box 162 is not checked, the CPU 71 performs processing as a normal compare mode.

In the case of the normal compare mode, the CPU 71 determines whether or not the reference camera is selected in step S303.

For example, the user can select the system camera 10 to be a reference by clicking the camera number in the list area 163.

If the reference camera is not selected, the CPU 71 ends the processing of FIG. 18. On the other hand, if the reference camera is selected, the CPU 71 proceeds from step S303 to step S304 and performs setting value comparison. That is, for each setting item, the CPU 71 confirms the setting value of each of the other system cameras 10 with reference to the setting value of the system camera 10 serving as the reference camera, and determines whether or not the setting values match each other.

Then, the CPU 71 causes the result of the setting value comparison in step S305 to be displayed. That is, in comparison with each setting item of the system camera 10 serving as the reference camera, a setting value different from that of the system camera 10 is highlighted.

If the auto compare function is turned on, the CPU 71 proceeds from step S302 to step S310. Then, the processing of steps S310, S311, and S312 is executed for each setting item.

In step S310, the CPU 71 selects one setting item. For example, “SR Live Lock” is selected.

In step S311, the CPU 71 sets a reference value for the selected setting item. For example, regarding “SR Live Lock”, the most common setting value is set as the reference value. The setting value for the setting item “SR Live Lock” is either “ON” or “OFF”, and in the case of FIG. 17, “OFF” is the majority, so “OFF” is used as the reference value.

In step S312, the CPU 71 compares the installation value of the system camera 10 of each camera number with the reference value, and determines matching/mismatching.

In step S313, the CPU 71 confirms an unprocessed setting item, and if there is an unprocessed setting item, returns to step S310 and selects the next setting item. For example, “HDR Format-Output” is selected. Then, the CPU 71 uses the setting value of the majority as the reference value in step S311, compares the installation values of the system cameras 10 of the respective camera numbers with the reference value in step S312, and determines matching/mismatching.

In this way, the above processing is performed for each setting item, and when there are no unprocessed setting items, the CPU 71 proceeds from step S313 to step S314, and causes display according to the comparison result of step S312 for each setting item to be executed.

That is, the setting values different from the reference values of the majority are highlighted as illustrated in FIG. 17.

By performing the processing of the compare function and the auto compare function on the HDR screen 28 as described above, the user can easily find the system camera 10 having different setting values.

### 3. SUMMARY AND MODIFICATIONS

According to the above-described embodiments, the following effects can be obtained.

The information processing device 70 as the server device 4 of the embodiment includes the UI control unit 71a that performs control to cause a list of setting values of setting items related to a plurality of system cameras 10 to be displayed, to perform difference determination processing of setting values for each of common setting items related to a plurality of the system cameras 10, and to cause display according to a difference determination result to be executed together with the list display.

For example, the difference determination processing is determination processing in the smart alert function or determination processing by the auto compare function.

In a case where the plurality of system cameras 10 is operated to perform broadcasting and distribution, the setting values for each system camera 10 can be listed, which is suitable for monitoring. Therefore, displaying a list of various setting values for each of the plurality of system cameras 10 and clearly indicating setting values having notable differences are extremely useful in the operation of the video engineer, and improve the efficiency of the monitoring work.

Note that the embodiment has been described with an example in which the plurality of system cameras 10 is set as the monitoring target as the system camera 10 including the camera 2 and the CCU 3. However, in a case where the CCU 3 is not used, the technology of the present disclosure can also be applied to a camera setting monitoring system for a plurality of the cameras 2.

In the embodiment, an example has been described in which the UI control unit 71a performs the difference determination processing using the time-series data of the setting values of the common setting items related to the plurality of system cameras 10 (see FIGS. 8 to 13).

In a case where the plurality of system cameras 10 is operated to perform broadcasting and distribution, the setting values for image creation of the system cameras 10 need to be matched so that a sense of discomfort does not appear on a screen of the broadcast video due to switching of the system cameras 10 to be the main line video. Therefore, as the smart alert function, a function of dynamically comparing and analyzing the setting values of the plurality of system cameras 10 is provided. Since it is necessary to finely adjust the setting values in real time according to the angle of view and the subject, it is not sufficient that the setting values are simultaneously operated by the system cameras 10, and it is not sufficient that the setting values completely match. Then, since the appropriate setting value varies according to the subject, the abnormal value and the normal value cannot be statically defined. Therefore, in the difference determination processing, comparison and analysis are dynamically performed using the time-series data of the setting values. As a result, the setting value that becomes the outlier can be determined and presented to the user.

In the embodiment, an example has been described in which, in the difference determination processing, the UI control unit 71a generates the feature amount information on the basis of the time-series data of the setting values of the common setting items related to the plurality of system cameras 10, performs clustering based on the feature amount information, and determines a setting value that is an outlier from the clustering (see FIGS. 12 and 13).

For example, in the smart alert function, in the difference determination processing, the feature amount space is generated using the time-series data of the setting value, and clustering is performed to determine an outlier (abnormal value). As a result, it is easy to find an unnatural setting value as seen from the setting values of the other system cameras 10 as a time-series change in the setting value. It is possible to appropriately determine and present an unnatural setting that cannot be determined from static setting value comparison.

In the embodiment, an example has been described in which the UI control unit 71a causes a list of the current setting values of the plurality of system cameras 10 to be displayed for each setting item, and causes the setting value determined to be the outlier by the difference determination processing to be indicated on the list (see FIGS. 8, 9, and 10).

On the paint screen 25, the current setting value of each system camera 10 is displayed in the setting value current value area 127. In the setting value current value area 127, the setting value determined to be an outlier is displayed, for example, in a different manner. For example, the setting value determined to be an outlier is highlighted or displayed in a conspicuous color. As a result, the system camera 10 in which the setting value is an outlier that is not equivalent to the setting values of the other system cameras 10 and the setting items thereof are easy to understand and suitable for the operation.

In the embodiment, an example has been described in which the UI control unit 71a causes time-series display of the setting values of the plurality of system cameras 10 to be executed for each setting item, and causes the setting value determined to be an outlier by the difference determination processing to be indicated on the time-series display (see FIGS. 8, 9, and 10).

On the paint screen 25, a change in the setting value of each system camera 10 is displayed in the setting value time-series area 125. In the setting value time-series area 125, the setting value determined to be an outlier is displayed in a mode different from the setting value that is not the outlier. For example, the setting value determined to be an outlier is highlighted or displayed in a conspicuous color. As a result, a change in the camera 2 having the setting value that is an outlier that is not equivalent to the setting values of the other system cameras 10 and the setting items thereof can be easily understood.

In the embodiment, an example has been described in which the UI control unit 71a variably sets the determination sensitivity for determining that the setting value is an outlier that is not equivalent to the setting values of the other system cameras 10 in the difference determination processing according to the threshold operation by the user (see FIGS. 8 to 13).

The threshold slider 124 is prepared on the paint screen 25 so that the user can change the threshold, that is, the sensitivity for abnormality determination. The UI control unit 71a varies the determination distance of the outlier after clustering according to the threshold set by the threshold slider 124. As a result, the user can optionally set the determination sensitivity of the outlier in step S206 in FIG. 13.

In the embodiment, an example has been described in which the UI control unit 71a sets execution or non-execution of the display control processing according to the difference determination processing and the difference determination result according to the user's operation (see FIGS. 8, 9, 10, and 13).

The smart alert button 123 is prepared on the paint screen 25, and the smart alert function is turned on/off by a user's operation. As a result, in each setting value box 120, the setting value time-series area 125 and the setting value current value area 127 can be switched between normal display and display of the smart alert function. That is, the smart alert function can be executed as necessary.

In the embodiment, an example has been described in which the UI control unit 71a, as the difference determination processing, performs the processing of matching determination on whether the setting values of the common setting items related to the plurality of system cameras 10 match the reference values (see FIGS. 16 to 18).

As the auto compare function of the HDR screen 28, a function of comparing the setting values of the setting items of the plurality of system cameras 10 with reference values is provided. As a result, a setting value having a value different from the reference value can be automatically determined and displayed.

In the embodiment, an example has been described in which the UI control unit 71a, in the difference determination processing, automatically sets the reference value on the basis of the setting values of the plurality of system cameras 10 for each setting item (see step S311 in FIG. 18).

In the auto compare function, the reference value is set from the setting values of the plurality of system cameras 10 for each setting item. For example, a setting value adopted in the largest number of system cameras 10 is used as a reference. This makes it possible to clearly indicate the setting value different from the reference value even when the user does not select the system camera 10 to be a reference.

In the embodiment, an example has been described in which the UI control unit 71a causes a list of the current setting values of the plurality of system cameras 10 to be displayed for each setting item, and causes the setting value determined not to be an equivalent to a reference value by the difference determination processing to be indicated on the list display (see step S314 in FIGS. 16, 17, and 18).

On the HDR screen 28, the current setting value of each system camera 10 is displayed in the list area 163. In the list area 163, the setting value different from the reference value is displayed in a mode different from the setting value equivalent to the reference value. For example, the setting value determined to be an outlier is highlighted or displayed in a conspicuous color. As a result, the camera 2 having the setting value that is not equivalent to the other reference values and its setting item thereof are easy to understand, and are suitable for the operation.

In the embodiment, an example has been described in which the UI control unit 71a causes the time-series display of the setting values or the detection values related to the plurality of system cameras 10 to be executed.

For example, on the camera cable screen 24 (FIG. 7), the time-series display is performed in the light reception level time-series area 100 and the light reflection time-series area 101. On the paint screen 25 (FIGS. 8, 9, and 10), the time-series display of the setting values of the system cameras 10 is performed in the setting value time-series area 125. On the log screen 26 (FIG. 14), the time-series display is performed in the log time-series area 141. With these time-series displays, the user (video engineer) can easily recognize changes in various setting values and detection values, which can be used for operations.

Note that the detection value indicates a light reception level or light reflection displayed on the camera cable screen 24, a log on the log screen 26, and the like.

In the embodiment, an example has been described in which the UI control unit 71a causes a list display of the current setting values or the detection values related to the plurality of system cameras 10 and time-series display of the setting values or the detection values related to the plurality of system cameras 10 to be displayed on the same screen.

For example, on the camera cable screen 24 (FIG. 7), the time-series display is performed in the light reception level time-series area 100 and the light reflection time-series area 101, and the current detection value is displayed on the same screen in the light reception level current value area 103 and the light reflection current value area 105. On the paint screen 25 (FIGS. 8, 9, and 10), the setting value time-series area 125 and the setting value current value area 127 are displayed on the same screen. With these displays, the user (video engineer) can confirm various setting values and detection values together with the current values and changes, which is suitable for grasping the situation of each system camera 10.

In the embodiment, an example has been described in which the UI control unit 71a causes the setting value panel 35 indicating the setting item and the setting value for each of the plurality of system cameras 10, and the sub control panel 36 commonly used to operate the setting values for the plurality of system cameras 10 to be displayed (see FIGS. 4 and 5).

On the operation panel screen 22, the setting value panels 35 corresponding to the plurality of system cameras 10 are displayed, and the sub control panel 36 is displayed. The setting values of various setting items related to each system camera 10 are displayed by the setting value panel 35, so that the user can recognize the setting values. In a case where the user wants to operate the setting value, the sub control panel 36 is used. As a result, since the operation elements can be shared while the setting values of the setting items of the system cameras 10 are clearly indicated, it is possible to provide a user interface with good operability without making the screen too complicated.

In the embodiment, an example has been described in which the UI control unit 71a causes the setting value of the setting item selected by the user on the setting value panel 35 to be varied by the operation of the sub control panel 36 (see steps S101 and S102 in FIG. 6).

As a result, the user can operate the setting value on the sub control panel 36 only by selecting the setting item having the setting value that is desired to be changed.

In the embodiment, an example has been described in which the UI control unit 71a causes display indicating the system camera 10 to be operated and the setting items to be performed on the sub control panel 36 (see FIG. 5).

That is, the camera 2 to be operated and the setting items thereof are clearly indicated by the camera number 40 and the item name 41. As a result, the user can perform an operation while recognizing the system camera 10 that is currently the operation target and the setting item.

In the embodiment, an example has been described in which the UI control unit 71a causes a plurality of types of operation elements to be displayed as operation elements for varying the setting value on the sub control panel 36 (see FIG. 5).

For example, a plurality of operation elements that change the setting values are provided as the up/down button 43 and the adjuster 45. As a result, the plurality of operation elements can be selectively used when it is desired to change the setting value for one step or when it is desired to greatly change the setting value.

In the embodiment, the server device 4 causes the terminal device 5 to display an image including a list of the setting values and a display according to the difference determination result of the difference determination processing (see FIG. 1).

This enables system monitoring and remote operation using a PC, a tablet terminal device, a smartphone, or the like as the terminal device 5.

Note that various modifications are conceivable regarding the processing of the UI control unit 71a.

For example, each screen as a monitoring screen may be equipped with a full customization function that allows the user to optionally change the setting items and the layout to be displayed.

A function of recording an operation history of image creation or a function of an automatic operation may be added.

For example, a function of recording and reproducing an image creation operation of the system camera 10 may be provided.

Furthermore, a function of making the operation efficient may be provided by storing setups of image creation for each weather and applying the setups each time.

Furthermore, a function may be provided such that a new video engineer refers to an operation history of an experienced video engineer to be useful for learning.

The program according to the embodiment is a program for causing an arithmetic device such as the server device 4, for example, a processor such as a CPU or a DSP, or a device including these to execute the processing illustrated in FIGS. 6, 13, and 18 described above.

That is, the program according to the embodiment is a program for causing an information processing device to execute control to cause a list of the setting values of the setting items related to a plurality of cameras (for example, the system camera 10) to be displayed, to perform the difference determination processing of the setting values for each of the common setting items related to the plurality of cameras, and to cause display according to the difference determination result to be executed together with the list display.

With such a program, the server device 4 that provides the UI screen as in the embodiment can be implemented by the information processing device 70.

The program according to the embodiment described above can be stored in advance in an HDD as a storage medium built in a device such as a computer device, a ROM in a microcomputer including a CPU, or the like. Furthermore, such a program can be temporarily or permanently stored (recorded) in a removable recording medium such as a flexible disk, a compact disc read only memory (CD-ROM), a magneto optical (MO) disk, a digital versatile disc (DVD), a Blu-ray Disc (registered trademark), a magnetic disk, a semiconductor memory, or a memory card. Such a removable recording medium can be provided as what is called package software.

Furthermore, such a program may be installed from the removable recording medium into a personal computer and the like, or may be downloaded from a download site through a network such as a local area network (LAN) or the Internet.

Furthermore, such a program is suitable for providing the server device 4 according to the embodiment in a wide range. For example, by downloading the program to a workstation, a personal computer, a communication device, a portable terminal device such as a smartphone or a tablet, a gaming device, a video device, a personal digital assistant (PDA), or the like, it is possible to cause these devices to function as the server device 4 of the present disclosure.

Note that, the effects described in the present specification are merely examples and are not limited, and other effects may be provided.

Note that the present technology can also have the following configurations.
(1)

An information processing device including:
a user interface control unit that performs control to cause a list of setting values of setting items related to a plurality of cameras to be displayed, to perform difference determination processing of setting values for each of common setting items related to a plurality of the cameras, and to cause display according to a difference determination result to be executed together with the list display.
(2)

The information processing device according to (1), in which
the user interface control unit
performs the difference determination processing using time-series data of setting values of common setting items related to a plurality of the cameras.
(3)

The information processing device according to (2), in which
the user interface control unit, in the difference determination processing,
generates feature amount information on the basis of time-series data of setting values of common setting items related to a plurality of the cameras, performs clustering based on the feature amount information, and determines a setting value that is an outlier from the clustering.
(4)

The information processing device according to (2) or (3), in which
the user interface control unit
causes a list of current setting values of a plurality of the cameras to be displayed for each setting item, and causes a setting value determined to be an outlier by the difference determination processing to be indicated on the list display.
(5)

The information processing device according to any one of (2) to (4), in which
the user interface control unit
causes time-series display of setting values of a plurality of the cameras to be executed for each setting item, and causes a setting value determined to be an outlier by the difference determination processing to be indicated on the time-series display.
(6)

The information processing device according to any one of (2) to (5), in which
the user interface control unit
variably sets determination sensitivity for determining that a setting value is an outlier that is not equivalent to other cameras in the difference determination processing according to a threshold operation by a user.
(7)

The information processing device according to any one of (2) to (6), in which
the user interface control unit
sets execution or non-execution of display control processing according to the difference determination processing and the difference determination result according to a user's operation.
(8)

The information processing device according to (1), in which
the user interface control unit,
as the difference determination processing, performs a processing of matching determination on whether a setting value of a common setting item related to a plurality of the cameras matches a reference value.
(9)

The information processing device according to (8), in which
the user interface control unit, in the difference determination processing,
automatically sets the reference value on the basis of the setting values of a plurality of the cameras for each setting item.
(10)

The information processing device according to (8) or (9), in which
the user interface control unit
causes a list of current setting values of a plurality of the cameras to be displayed for each setting item, and causes a setting value determined not to be an equivalent to a reference value by the difference determination processing to be indicated on the list display.
(11)

The information processing device according to any one of (1) to (10), in which
the user interface control unit
causes time-series display of setting values or detection values related to a plurality of the cameras to be executed.
(12)

The information processing device according to any one of (1) to (11), in which
the user interface control unit
causes a list display of current setting values or detection values related to a plurality of the cameras,
and time-series display of setting values or detection values related to the plurality of cameras to be displayed on the same screen.
(13)

The information processing device according to any one of (1) to (12), in which
the user interface control unit
causes a setting value panel indicating a setting item and a setting value for each of a plurality of the cameras, and a sub control panel commonly used to operate setting values for a plurality of the cameras to be displayed.
(14)

The information processing device according to (13), in which
the user interface control unit
causes a setting value of a setting item selected by a user on the setting value panel to be varied by an operation of the sub control panel.
(15)

The information processing device according to (13) or (14), in which
the user interface control unit
causes display of the camera to be operated and the setting item to be performed in the sub control panel.
(16)

The information processing device according to any one of (13) to (15), in which
the user interface control unit
causes a plurality of types of operation elements to be displayed as operation elements for varying setting values on the sub control panel.
(17)

The information processing device according to any one of (1) to (16), in which
the information processing device is a server device that causes a terminal device to display an image including the list display and a display according to a difference determination result of the difference determination processing.
(18)

An information processing method, in which
an information processing device
performs control to cause a list of setting values of setting items related to a plurality of cameras to be displayed, to perform difference determination processing of setting values for each of common setting items related to a plurality of the cameras, and to cause display according to a difference determination result to be executed together with the list display.
(19)

A program for causing an information processing device to execute
control to cause a list of setting values of setting items related to a plurality of cameras to be displayed, to perform difference determination processing of setting values for each of common setting items related to a plurality of the cameras, and to cause display according to a difference determination result to be executed together with the list display.

### REFERENCE SIGNS LIST

1 Camera setting monitoring system
2 Camera
3 CCU
4 Server device
5 Terminal device
6 Network
7 Cable
8 Optical fiber cable
10 System camera
22 Operation panel screen
25 Paint screen
28 HDR screen
35 Setting value panel
36 Sub control panel
70 Information processing device
71 CPU
71a UI control unit
120 Setting value box
123 Smart alert button
124 Threshold slider
125 Setting value time-series area
127 Setting value current value area
161 Compare button
162 Auto compare box
163 List area

1. An information processing device comprising:
a user interface control unit that performs control to cause a list of setting values of setting items related to a plurality of cameras to be displayed, to perform difference determination processing of setting values for each of common setting items related to a plurality of the cameras, and to cause display according to a difference determination result to be executed together with the list display.

2. The information processing device according to claim 1, wherein
the user interface control unit
performs the difference determination processing using time-series data of setting values of common setting items related to a plurality of the cameras.

3. The information processing device according to claim 2, wherein
the user interface control unit, in the difference determination processing,
generates feature amount information on a basis of time-series data of setting values of common setting items related to a plurality of the cameras, performs clustering based on the feature amount information, and determines a setting value that is an outlier from the clustering.

4. The information processing device according to claim 2, wherein
the user interface control unit
causes a list of current setting values of a plurality of the cameras to be displayed for each setting item, and causes a setting value determined to be an outlier by the difference determination processing to be indicated on the list display.

5. The information processing device according to claim 2, wherein
the user interface control unit
causes time-series display of setting values of a plurality of the cameras to be executed for each setting item, and causes a setting value determined to be an outlier by the difference determination processing to be indicated on the time-series display.

6. The information processing device according to claim 2, wherein
the user interface control unit
variably sets determination sensitivity for determining that a setting value is an outlier that is not equivalent to other cameras in the difference determination processing according to a threshold operation by a user.

7. The information processing device according to claim 2, wherein
the user interface control unit
sets execution or non-execution of display control processing according to the difference determination processing and the difference determination result according to a user's operation.

8. The information processing device according to claim 1, wherein
the user interface control unit,
as the difference determination processing, performs a processing of matching determination on whether a setting value of a common setting item related to a plurality of the cameras matches a reference value.

9. The information processing device according to claim 8, wherein
the user interface control unit, in the difference determination processing,
automatically sets the reference value on a basis of the setting values of a plurality of the cameras for each setting item.

10. The information processing device according to claim 8, wherein
the user interface control unit
causes a list of current setting values of a plurality of the cameras to be displayed for each setting item, and causes a setting value determined not to be an equivalent to a reference value by the difference determination processing to be indicated on the list display.

11. The information processing device according to claim 1, wherein
the user interface control unit
causes time-series display of setting values or detection values related to a plurality of the cameras to be executed.

12. The information processing device according to claim 1, wherein
the user interface control unit
causes a list display of current setting values or detection values related to a plurality of the cameras,
and time-series display of setting values or detection values related to the plurality of cameras to be displayed on the same screen.

13. The information processing device according to claim 1, wherein
the user interface control unit
causes a setting value panel indicating a setting item and a setting value for each of a plurality of the cameras, and a sub control panel commonly used to operate setting values for a plurality of the cameras to be displayed.

14. The information processing device according to claim 13, wherein
the user interface control unit
causes a setting value of a setting item selected by a user on the setting value panel to be varied by an operation of the sub control panel.

15. The information processing device according to claim 13, wherein
the user interface control unit
causes display indicating the camera to be operated and the setting item to be performed in the sub control panel.

16. The information processing device according to claim 13, wherein
the user interface control unit
causes a plurality of types of operation elements to be displayed as operation elements for varying setting values on the sub control panel.

17. The information processing device according to claim 1, wherein
the information processing device is a server device that causes a terminal device to display an image including the list display and a display according to a difference determination result of the difference determination processing.

18. An information processing method, wherein
an information processing device
performs control to cause a list of setting values of setting items related to a plurality of cameras to be displayed, to perform difference determination processing of setting values for each of common setting items related to a plurality of the cameras, and to cause display according to a difference determination result to be executed together with the list display.

19. A program for causing an information processing device to execute
control to cause a list of setting values of setting items related to a plurality of cameras to be displayed, to perform difference determination processing of setting values for each of common setting items related to a plurality of the cameras, and to cause display according to a difference determination result to be executed together with the list display.
